(19) United States
(12) Patent Application Publication
(10) Pub. No.: US 2013/0162875 A1
(43) Pub. Date: Jun. 27, 2013

(54) Method and Device for Measuring a Difference in Illumination

(71) Applicants: Anton Schick, Velden (DE); Utz Wever, Munchen (DE); Yayun Zhou, Munchen (DE)

(72) Inventors: Anton Schick, Velden (DE); Utz Wever, Munchen (DE); Yayun Zhou, Munchen (DE)

(21) Appl. No.: 13/821,079

(22) PCT Filed: Aug. 17, 2011
(86) PCT No.: PCT/EP11/64138

§ 371 Date: Mar. 6, 2013

Related U.S. Application Data
(60) Provisional application No. 61/383,448, filed on Sep. 16, 2010.

(30) Foreign Application Priority Data
Nov. 23, 2010 (EP) 10192212.8

(51) Int. Cl. G01J 1/42; H04N 5/335

(52) U.S. Cl. CPC G01J 1/4228; H04N 5/335
USPC 348/311; 250/208.2

(57) ABSTRACT

A device for detecting a difference in illumination may include at least two adjacent photoelectric sensor element groups on which light falls during an adjustable illumination time, said light being converted to a quantity of electric charge, which corresponds to the quantity of light falling on each sensor element group during the illumination time, and having a detector, which detects a minimum charge of the charge quantities generated by both photoelectric sensor element groups and subtracts said minimum charge from both photoelectric sensor element groups. The device can be used in a variety of applications, e.g., for digital cameras and medical devices. Wavelet coefficients can be generated directly using metrological and sensory means and may be available for further signal processing.

### CROSS-REFERENCE TO RELATED APPLICATIONS

This application is a U.S. National Stage Application of International Application No. PCT/EP2011/064138 filed Aug. 17, 2011, which designates the United States of America, and claims priority to U.S. Provisional Patent Application No. 61/383,448 filed Sep. 16, 2010 and EP Patent Application No. 10192212.8 filed Nov. 23, 2010. The contents of which are hereby incorporated by reference in their entirety.

### TECHNICAL FIELD

The disclosure relates to a method and apparatus for measuring a difference in illumination, in particular for a digital camera.

### BACKGROUND

With conventional imaging facilities the quantity of light received by the respective light-sensitive sensor element, in other words the number of light photons arriving there, is converted to electric charges in each light-sensitive sensor element or pixel and a corresponding voltage value is output. With such conventional apparatuses therefore absolute values of the received light quantities are recorded and then further processed by a signal processing circuit. For example the recorded absolute values are transformed to so-called wavelet coefficients by means of hardware or software for further processing. In this process the difference is formed between the light intensity or voltage values recorded by sensory means in adjacent sensor elements or sensor element groups. One disadvantage of such a conventional arrangement is therefore that an additional process-related signal processing step is required to form the difference required for many applications to determine a difference in illumination between photoelectric sensor elements or photoelectric sensor element groups.

A further disadvantage of such a conventional arrangement is that saturation effects, which occur when sensor elements are over-illuminated, cannot be corrected.

### SUMMARY

One embodiment provides a method for measuring a difference in illumination with the steps: (a) illuminating at least two adjacent photoelectric sensor element groups with light during an illumination time, said sensor element groups converting the light in each instance to a quantity of electric charge, which corresponds to the quantity of light striking the respective sensor element group during the illumination time; and (b) discharging both adjacent photoelectric sensor element groups during the illumination time so that the one of the two photoelectric sensor element groups which light strikes with a lower light intensity than the other of the two photoelectric sensor element groups has no electric charge and the other of the two photoelectric sensor element groups has a quantity of electric charge which corresponds to the difference in illumination between the quantities of light striking the two adjacent sensor element groups.

In a further embodiment, the two adjacent photoelectric sensor element groups are discharged continuously or discontinuously with the same charge value at the same time during the illumination time.

In a further embodiment, electric charge components are taken out regularly at predetermined time intervals from the one of the two adjacent photoelectric sensor element groups, which light strikes with a higher light intensity during the illumination time, to prevent saturation of the photoelectric sensor element groups.

In a further embodiment, the electric charge components taken out are summed to form a quantity of electric charge, which corresponds to the difference in illumination between the quantities of light striking the two adjacent sensor element groups.

In a further embodiment, each photoelectric sensor element group has 2.2²ⁿ adjoining photoelectric sensor elements of a sensor element field for the direct determination of wavelet coefficients, where n is a whole number n≧0.

In a further embodiment, a number of photoelectric sensor elements of the sensor element field are connected together to form a photoelectric sensor element group before illumination.

In a further embodiment, the photoelectric sensor element groups comprise of CMOS sensor elements.

In a further embodiment, the two adjacent photoelectric sensor element groups are read out for signal analysis after the end of the illumination time.

In a further embodiment, the quantity of electric charge generated, which corresponds to the difference in illumination between the quantities of light striking the two adjacent sensor element groups, is read out from the one of the two adjacent sensor element groups, which light strikes with a higher light intensity during the illumination time, and corresponds to a wavelet coefficient with the read out sign for the difference.

In a further embodiment, the photoelectric sensor elements of the sensor element groups are sensitive to electromagnetic radiation in a predetermined frequency range.

Another embodiment provides an apparatus for recording a difference in illumination having: (a) at least two adjacent photoelectric sensor element groups, which light strikes during a settable illumination time, said light being converted in each instance to a quantity of electric charge, which corresponds to the quantity of light striking the respective sensor element group during the illumination time; and (b) a detector, which detects a minimum charge of the charge quantities generated by the two photoelectric sensor element groups and subtracts it from both photoelectric sensor element groups.

In a further embodiment, a read-out circuit is provided, which reads out the photoelectric sensor element groups to a signal analysis circuit after the end of the illumination time for signal analysis purposes.

In a further embodiment, the photoelectric sensor element groups each have 2.2²ⁿ adjoining photoelectric sensor elements of a sensor element field for the direct determination of wavelet coefficients, where n is a whole number n≧0.

In a further embodiment, a control circuit is provided, which connects together a number of photoelectric sensor elements to form a sensor element group before the start of the illumination time.

In a further embodiment, a sensor element field is provided, the sensor elements of which are illuminated in a successively switchable manner, or wherein a number of sensor element fields are disposed above one another, or wherein a number of sensor element fields are disposed above one another or next to one another and a beam splitter is provided for image multiplication by the sensor element fields.

Another embodiment provides a digital camera having an apparatus as disclosed above.

### BRIEF DESCRIPTION OF THE DRAWINGS

Exemplary embodiments will be explained in more detail below on the basis of the schematic drawings, wherein:

FIG. 1 shows a block diagram of an example apparatus for recording a difference in illumination, according to an example embodiment;

FIG. 2 shows a simple flow diagram of an example method for measuring a difference in illumination, according to an example embodiment;

FIG. 3 shows a signal diagram to describe an example mode of operation of a method and apparatus for recording a difference in illumination according to an example embodiment;

FIG. 4 shows a signal diagram to explain a problem underlying another aspect of a disclosed method and apparatus for recording a difference in illumination; and

FIG. 5 shows a signal diagram to explain the mode of operation of an method and apparatus for recording a difference in illumination, according to another example embodiment.

### DETAILED DESCRIPTION

Embodiments of the present disclosure provide a method and apparatus that allow a difference in illumination to be measured directly.

Some embodiments provide a method for measuring a difference in illumination with the steps: illuminating at least two adjacent photoelectric sensor element groups with light during an illumination time, said sensor element groups converting the light in each instance to a quantity of electric charge, which corresponds to the quantity of light striking the respective sensor element group during the illumination time; and discharging both adjacent photoelectric sensor element groups during the illumination time so that the one of the two photoelectric sensor element groups which the light strikes with a lower light intensity than the other of the two photoelectric sensor element groups has no electric charge and the other of the two photoelectric sensor element groups has a quantity of electric charge which corresponds to the difference in illumination between the quantities of light striking the two adjacent sensor element groups.

With the disclosed method therefore differences in illumination between two adjacent photoelectric sensor element groups, each of which comprises at least one sensor element, are measured directly and output as a signal. After analog-digital conversion this output signal corresponds to a wavelet coefficient, which can be processed directly in a data processing facility. With the disclosed method therefore the difference is formed directly on a sensor chip, which comprises the photoelectric sensor element groups (active pixel sensor).

In one embodiment of the method the two adjacent photoelectric sensor element groups are discharged continuously with the same charge value at the same time during the illumination time.

In a further embodiment of the method the two adjacent photoelectric sensor element groups are discharged discontinuously at the same time during the illumination time. In one embodiment of the method electric charge components are taken out regularly at predetermined time intervals from the one of the two adjacent photoelectric sensor element groups, which light strikes with a higher light intensity during the illumination time, to prevent saturation of the photoelectric sensor element group.

In one embodiment the electric charge components taken out are summed to form a quantity of electric charge, which corresponds to the difference in illumination between the quantities of light striking the two adjacent sensor element groups.

In one embodiment of the method each photoelectric sensor element group has 2.2²ⁿ adjoining photoelectric sensor elements of a sensor element field, where n is a whole number n≧0.

In one embodiment of the method a number of photoelectric sensor elements of the sensor element field are connected together to form a photoelectric sensor element group before illumination.

In one embodiment of the method the photoelectric sensor element groups comprise CMOS sensor elements.

In one embodiment of the method the two adjacent photoelectric sensor element groups are read out for signal analysis after the end of the illumination time.

In a further embodiment of the method the quantity of electric charge generated, which corresponds to the difference in illumination between the quantities of light striking the two adjacent sensor element groups, is read out from the one of the two adjacent sensor element groups, which light strikes with a higher light intensity during the illumination time, and corresponds to a wavelet coefficient.

In one embodiment of the method the photoelectric sensor elements of the sensor element groups are sensitive to electromagnetic radiation in a predetermined frequency range.

Other embodiments provide an apparatus for recording a difference in illumination, having: at least two adjacent photoelectric sensor element groups, which light strikes during a settable illumination time, said light being converted in each instance to a quantity of electric charge, which corresponds to the quantity of light striking the respective sensor element group during the illumination time; and having a detector, which detects a minimum charge of the charge quantities generated by the two photoelectric sensor element groups and subtracts it from both photoelectric sensor element groups.

In one embodiment of the apparatus said apparatus has a read-out circuit, which reads out the photoelectric sensor element groups to a signal analysis circuit after the end of the illumination time for signal analysis purposes, wherein the read-out circuit of the signal analysis circuit may report or transmit a charge difference and the sign of said charge difference.

In one embodiment of the apparatus the photoelectric sensor element groups each have 2.2²ⁿ adjoining photoelectric sensor elements of a sensor element field, where n is a whole number n≧0.

In a further embodiment of the apparatus a control circuit is provided, which connects together a number of photoelectric sensor elements to form a sensor element group before the start of the illumination time.

In a further embodiment of the apparatus a number of sensor element fields are disposed above one another.

In one embodiment a number of sensor element fields are disposed next to one another and a beam splitter is provided in front of them for image multiplication.

Other embodiments provide a digital camera with an apparatus for recording a difference in illumination, having: at least two adjacent photoelectric sensor element groups, which light strikes during a settable illumination time, said light being converted in each instance to a quantity of electric charge, which corresponds to the quantity of light striking the respective sensor element group during the illumination time; and having a detector, which detects a minimum charge of the charge quantities generated by the two photoelectric sensor element groups and subtracts it from both photoelectric sensor element groups.

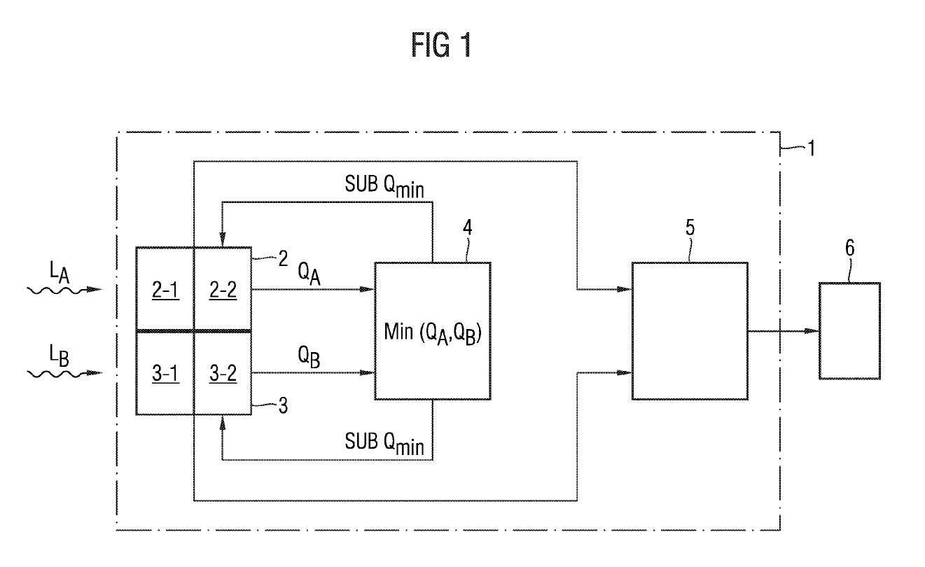

As shown in FIG. 1, an example apparatus 1 comprises at least two adjacent photoelectric sensor element groups 2, 3, each of which comprises a number of photoelectric sensor elements 2-i, 3-i. In the exemplary embodiment illustrated in FIG. 1 each of the two adjacent photoelectric sensor element groups 2, 3 comprises two photoelectric sensor elements 2-1, 2-2 or 3-1, 3-2. Generally each photoelectric sensor element group 2, 3 comprises 2.2²ⁿ adjoining photoelectric sensor elements of a sensor element field to determine wavelet coefficients, where n is a whole number n≧0, i.e. 2, 8 etc. sensor elements. Accordingly each sensor element group 2, 3 comprises at least two photoelectric sensor elements in this embodiment for the direct generation of wavelet coefficients. In alternative embodiments a sensor element group 2, 3 for other applications can also include at least one sensor element or pixel. During a settable illumination time T_{B} light strikes the two adjacent photoelectric sensor element groups 2, 3. In the example illustrated in FIG. 1 a quantity of light L_{A} strikes the first photoelectric sensor element group 2 and a quantity of light L_{B} strikes the second photoelectric sensor element group 3. The light striking the respective photoelectric sensor element group 2, 3 is converted in each instance by the associated photoelectric sensor element group 2, 3 to a corresponding quantity of electric charge Q_{A}, Q_{B}. This quantity of electric charge Q_{A}, Q_{B} corresponds to the quantity of light L_{A}, L_{B} striking the respective sensor element group 2, 3 during the illumination time T_{B}. The apparatus 1 also comprises a detector 4, which detects a minimum charge Qmin of the charge quantities Q_{A}, Q_{B} generated by the two photoelectric sensor element groups 2, 3 and subtracts it from both photoelectric sensor element groups 2, 3 respectively.

Also provided in the apparatus 1 in the embodiment illustrated in FIG. 1 is a read-out circuit 5, which reads out the photoelectric sensor element groups 2, 3 to a signal analysis circuit after the end of the illumination time T_{B} for signal analysis purposes.

In the exemplary embodiment illustrated in FIG. 1 the read-out circuit 5 is integrated in the apparatus 1 for recording the difference in illumination. In an alternative embodiment the apparatus 1 for recording a difference in illumination only comprises the photoelectric sensor element groups and the detector 4.

In a further embodiment of the apparatus 1a control circuit (not shown in FIG. 1) is also provided, which connects together a number of photoelectric sensor elements to form a sensor element group 2, 3 before the start of the illumination time. The size and scope of the sensor element groups 2, 3 can be set by the control circuit, it being possible for the photoelectric sensor elements 2-i, 3-i illustrated in FIG. 1 to form part of a larger sensor element field with a plurality of photoelectric sensor elements.

In a further possible embodiment this sensor element field comprises a plurality of photoelectrically sensitive CMOS sensor elements. In the embodiment illustrated in FIG. 1 the apparatus 1 comprises a sensor element field. In an alternative embodiment the apparatus 1 can also have a number of sensor element fields disposed above one another. It is also possible to dispose a number of sensor element fields next to one another and provide a beam splitter for image multiplication. The area of the pixels or sensor elements can vary. The number of connected sensor elements can also be adjusted or controlled. In one possible embodiment this adjustment takes place dynamically, e.g. as a function of the light intensity.

In one embodiment of the apparatus 1 the photoelectric sensor elements of the sensor element field are sensitive to electromagnetic radiation in a predetermined frequency range ΔF. For example the photoelectric sensor elements are sensitive to light in a visible range. In an alternative embodiment the sensor element fields are sensitive to other frequency ranges, for example to ultraviolet radiation or infrared radiation. In a further possible embodiment the photoelectric sensor elements are sensitive to x-ray radiation for example.

In a further embodiment a number of sensor element fields disposed above one another are sensitive to electromagnetic radiation in the same frequency range. In an alternative embodiment sensor element fields disposed above one another are sensitive to electromagnetic radiation in different frequency ranges.

In one embodiment the apparatus for measuring a difference in illumination illustrated in FIG. 1 is integrated in a digital camera. In an alternative embodiment the embodiment illustrated in FIG. 1 is provided for example in an x-ray detector or a computed tomography system.

With the apparatus 1 illustrated in FIG. 1 each photoelectric sensor element or pixel is connected to a sensor node, which reports the locally generated electric charge Q to the detector 4. The ascertained lower charge of the two adjacent sensor element groups 2, 3 is subtracted from the current charge of the two sensor element groups 2, 3 by the detector 4. This means that the current electric charge Q is always zero on one of the two adjacent sensor element groups 2, 3 and the respective other sensor element group has a charge Q, which corresponds to the difference between the two quantities of light L_{A}, L_{B} striking the sensor element groups 2, 3. This charge difference ΔQ or light quantity difference is read out by a read-out circuit 5 after the end of the illumination time T_{B} and output to the signal analysis circuit 6 for further signal analysis. The read-out circuit 5 also reports the sign of the charge difference ΔQ to the signal analysis circuit 6. The signal analysis circuit 6 can comprise for example an analog-digital converter, which converts the charge or light quantity difference to a digital value, which corresponds directly to a wavelet coefficient. The wavelet coefficients thus generated directly by the apparatus 1 can then be further processed directly by electronic means, for example for signal compression, noise elimination and resharpening. It is also possible to transform the recorded wavelet coefficients back to real data by means of an inverse wavelet transformation.

The apparatus 1 for recording a difference in illumination is also particularly suitable for incoherent light, for example sunlight.

The apparatus 1 is used to measure wavelet coefficients of an image. The arrangement offers a significant dynamic gain for the image sensor as a whole, in other words the wavelet transformation on the image sensor represents a high dynamic range (HDR) sensor.

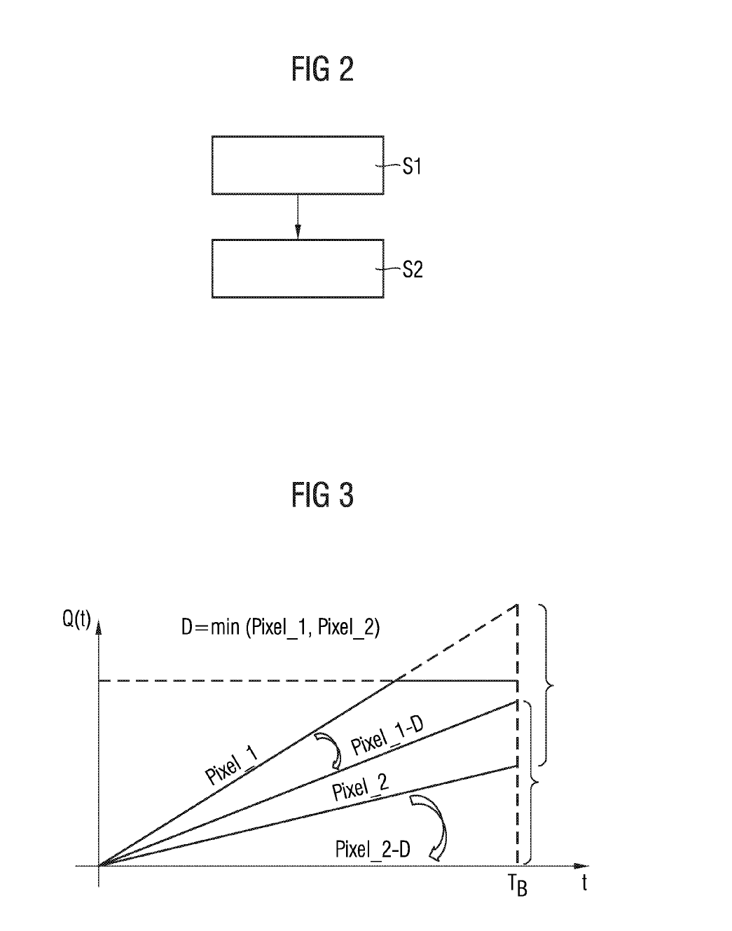

FIG. 2 shows a simple flow diagram to illustrate an exemplary embodiment of the method for measuring a difference in illumination.

In a first step S1 at least two adjacent photoelectric sensor element groups 2, 3 are illuminated with light during an illumination time T_{B}. In one possible embodiment the illumination time T_{B} can be set.

In one possible embodiment the sensor elements are actively switched to light-sensitive during the illumination time T_{B} and deactivated again after the end of the illumination time T_{B}. This can be done with the aid of a control circuit, which has a timer.

In an alternative embodiment the illumination time T_{B} is controlled by activating a diaphragm in front of the sensor field, which is opened during the illumination time.

The two adjacent photoelement groups 2, 3 in each instance convert the incident light in step S1 to a quantity of electric charge Q_{A}, Q_{B}, which corresponds to the quantity of light L_{A}, L_{B} of the light L striking the respective sensor element group 2, 3 during the illumination time T_{B}. During the illumination time T_{B} in step S2 both adjacent photoelectric sensor element groups 2, 3 are discharged so that the one of the two photoelectric sensor element groups 2, 3 which the light strikes with a lower light intensity than the other of the two photoelectric sensor element groups has no electric charge (Q=0) and the other of the two photoelectric sensor element groups 2, 3 has a quantity of electric charge Q which corresponds to the difference in illumination ΔL between the quantities of light L_{A}, L_{B} striking the two adjacent sensor element groups 2, 3 (ΔL=|L_{A}−L_{B}|) or is proportional thereto (Q˜ΔL).

In one possible embodiment the discharging of the two adjacent photoelectric sensor element groups 2, 3 can take place continuously during the illumination time T_{B}. In an alternative embodiment the simultaneous discharging of the two adjacent photoelectric sensor element groups 2, 3 takes place discontinuously during the illumination time T_{B}.

FIG. 3 shows an example signal diagram to further describe the mode of operation of the method and apparatus 1 for measuring a difference in illumination. As can be seen in FIG. 3, the electric charge Q generated by illumination is shown over time t. The charge profile for two adjacent photoelectric sensor elements Pixel 1, Pixel 2 is shown here for an illumination time T_{B}. The linear profile illustrated in FIG. 3 is exemplary, in other words the charge increase during the illumination time T_{B} does not necessarily have to be linear. In the example illustrated in FIG. 3 a larger quantity of light strikes the first pixel 1 than the second adjacent pixel 2, so that the charge Q(t) generated as a result increases until the first pixel 1 in the illustrated example reaches a saturation limit. With the disclosed method the quantity of charge generated by the second, more weakly illuminated pixel 2 is constantly taken from this more powerfully illuminated first pixel 1. As can be seen in FIG. 3, in the illustrated example this means that the first pixel 1 does not reach the saturation limit during the illumination time T_{B} and therefore the measured difference in illumination at the end of the illumination time T_{B} corresponds to the actual difference in light quantities.

In the disclosed method therefore the electric charges, i.e. the electrons, which result due to the light photons, are taken at the same time from both sensor elements or sensor element groups Pixel 1, Pixel 2, to keep the charge quantity of the more weakly illuminated sensor element group at zero. The electric charge Q generated by the more powerfully illuminated sensor element group is read out after the end of the illumination time and corresponds exactly to the light quantity difference ΔL. As can be seen directly from FIG. 3, the disclosed method and apparatus 1 for measuring a difference in illumination have the advantage that in many instances saturation of an electric sensor element group and therefore distortion of the measured difference can be prevented.

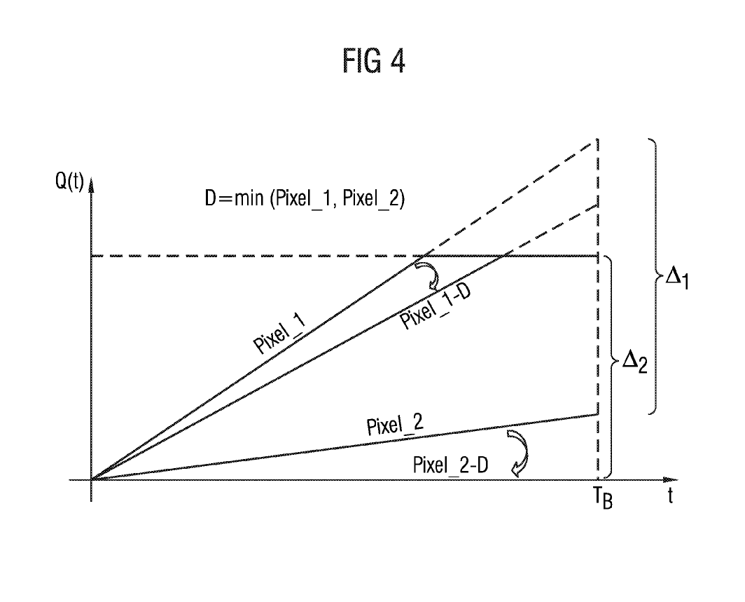

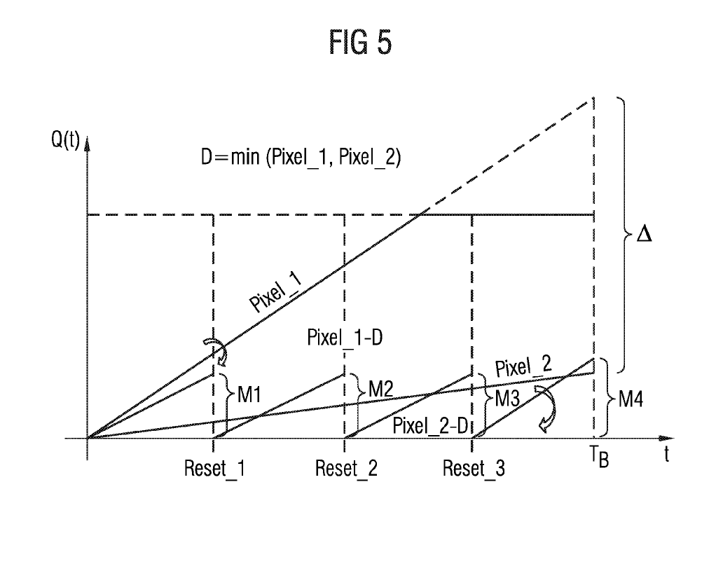

However, as illustrated in FIG. 4, with a correspondingly long illumination time T_{B} or with a high light intensity saturation of the more powerfully illuminated of the two adjacent photoelectric sensor element groups 2, 3 can occur. This causes distortion of the measured difference in relation to the actual light quantity difference ΔL. In one possible variant of the method this is prevented by regular discharging of the more powerfully illuminated sensor element group, as shown in FIG. 5. In this process electric charge components are taken out regularly at predetermined time intervals Δt from the one of the two adjacent photoelectric sensor element groups 2, 3, which light strikes with a higher light intensity during the illumination time T_{B}, to prevent saturation of the more powerfully illuminated photoelectric sensor element group. It is thus possible to prevent saturation of the more powerfully illuminated photoelectric sensor element group, i.e. Pixel 1 in the exemplary embodiment illustrated in FIG. 5. The electric charge components Mᵢ taken are summed to form a quantity of electric charge, which corresponds to the difference in illumination ΔL between the quantities of light L_{A}, L_{B} striking the two adjacent sensor element groups 2, 3. In one possible embodiment the predetermined time intervals Δt for taking out the electric charge components can be set. In the exemplary embodiment illustrated in FIG. 5 the illumination time T_{B} is divided into four time intervals for taking out charge components. In the exemplary embodiment illustrated in FIG. 5 the time intervals Δt for taking out electric charge components are of equal length. In further possible variants the time intervals Δt for taking out charge components can also vary. The shorter the time intervals Δt set for taking out electric charge component, the less likely it is that one of the two electric sensor element groups 2, 3 or Pixel 1, Pixel 2 will reach saturation. This variant in particular prevents a sensor element group or sensor elements over-controlling when the light intensity is high.

In a further possible variant, when the saturation limit is reached, a discharging of said sensor element group is brought about or triggered, to prevent over-saturation of the respective sensor element group. With this embodiment the generated charge is therefore monitored and compared with a threshold value.

The method or apparatus 1 for measuring a difference in illumination provides a dynamic range or contrast scope of any level. The same hardware can be used here for different environments. The method and apparatus 1 may allow on-chip data compression, thereby saving storage space. Higher frequencies or local frequencies of a structure, which is recorded by the camera, for example a grid, can be suppressed or eliminated during recording. In one possible embodiment the charge current of the pixel capacitances is detected and the current is regulated correspondingly. In an alternative embodiment the voltage at the capacitor or the pixel capacitance is detected and the voltage is regulated correspondingly by simultaneous charge dissipation.

The disclosed method or apparatus 1 for measuring a difference in illumination may be suitable for use in medical engineering, for example for x-ray detectors or computed tomography systems. Some further possible areas of use include remote reconnaissance, for example the generation of satellite images for cartography. The disclosed method and apparatus 1 are also suitable for digital cameras of end consumers.

What is claimed is:

1. A method for measuring a difference in illumination, comprising:
(a) illuminating two adjacent photoelectric sensor element groups with light during an illumination time, said sensor element groups converting the light in each instance to a quantity of electric charge, which corresponds to the quantity of light striking the respective sensor element group during the illumination time; and
(b) discharging both adjacent photoelectric sensor element groups during the illumination time such that the photoelectric sensor element group that light strikes with a lower light intensity than the other photoelectric sensor element group has no electric charge and the other photoelectric sensor element group has a quantity of electric charge that corresponds to a difference in illumination between the quantities of light striking the two adjacent sensor element groups.

2. The method of claim 1, wherein the two adjacent photoelectric sensor element groups are discharged continuously or discontinuously with the same charge value at the same time during the illumination time.

3. The method of claim 1, comprising taking out electric charge components regularly at predetermined time intervals from the photoelectric sensor element group that light strikes with a higher light intensity during the illumination time, thereby reducing or preventing saturation of the photoelectric sensor element groups.

4. The method of claim 3, comprising summing the electric charge components taken out to form a quantity of electric charge that corresponds to the difference in illumination between the quantities of light striking the two adjacent sensor element groups.

5. The method of claim 1, wherein each photoelectric sensor element group has 2.2²ⁿ adjoining photoelectric sensor elements of a sensor element field for the direct determination of wavelet coefficients, where n is a whole number n≧10.

6. The method of claim 5, wherein a number of photoelectric sensor elements of the sensor element field are connected together to form a photoelectric sensor element group before illumination.

7. The method of claim 1, wherein the photoelectric sensor element groups comprise CMOS sensor elements.

8. The method of claim 1, wherein the two adjacent photoelectric sensor element groups are read out for signal analysis after the end of the illumination time.

9. The method claim 1, wherein the quantity of electric charge generated, which corresponds to the difference in illumination between the quantities of light striking the two adjacent sensor element groups, is read out from the sensor element group that light strikes with a higher light intensity during the illumination time, and corresponds to a wavelet coefficient with the read out sign for the difference.

10. The method claim 1, wherein the photoelectric sensor elements of the sensor element groups are sensitive to electromagnetic radiation in a predetermined frequency range.

11. An apparatus for recording a difference in illumination, comprising:
(a) at least two adjacent photoelectric sensor element groups that light strikes during a settable illumination time, each sensor element group configured to convert the light sensor element group to a quantity of electric charge that corresponds to the quantity of light striking that sensor element group during the illumination time; and
(b) a detector configured to detect a minimum charge of the charge quantities generated by the two photoelectric sensor element groups and subtract the detected minimum charge from both photoelectric sensor element groups.

12. The apparatus of claim 11, comprising a read-out circuit configured to read out the photoelectric sensor element groups to a signal analysis circuit after the end of the illumination time for signal analysis purposes.

13. The apparatus of claim 11, wherein each photoelectric sensor element group has 2.2²ⁿ adjoining photoelectric sensor elements of a sensor element field for the direct determination of wavelet coefficients, where n is a whole number n≧0.

14. The apparatus of claim 11, comprising a control circuit that connects together a number of photoelectric sensor elements to form a sensor element group before the start of the illumination time.

15. The apparatus of claim 11, comprising a sensor element field comprising sensor elements that are illuminated in a successively switchable manner, or
wherein a number of sensor element fields are disposed above one another, or wherein a number of sensor element fields are disposed above one another or next to one another and a beam splitter is provided for image multiplication by the sensor element fields.

16. (canceled)

17. The apparatus of claim 11, comprising a sensor element field wherein a number of sensor element fields are disposed above one another.

18. The apparatus of claim 11, comprising a plurality of sensor element fields disposed above one another or next to one another and a beam splitter is provided for image multiplication by the sensor element fields.

19. A digital camera comprising:
an apparatus for recording a difference in illumination, comprising:
(a) at least two adjacent photoelectric sensor element groups that light strikes during a settable illumination time, each sensor element group configured to convert the light striking that sensor element group to a quantity of electric charge that corresponds to the quantity of light striking that sensor element group during the illumination time; and
(b) a detector configured to detect a minimum charge of the charge quantities generated by the two photoelectric sensor element groups and subtract the detected minimum charge from both photoelectric sensor element groups.
